(19) United States
(12) Patent Application Publication
(10) Pub. No.: US 2025/0304798 A1
(43) Pub. Date: Oct. 2, 2025

(54) EMULSION FOR WIDE TEMPERATURE RANGE SOUND DAMPENING PROPERTY

(71) Applicant: BASF SE, Ludwigshafen am Rhein (DE)

(72) Inventors: Senthilkumar RENGASAMY, Charlotte, NC (US); Sean Raymond GEORGE, Wyandotte, MI (US)

(21) Appl. No.: 18/863,069

(22) PCT Filed: May 5, 2023
(86) PCT No.: PCT/US2023/021198

§ 371 Date: Nov. 5, 2024

Related U.S. Application Data
(60) Provisional application No. 63/339,041, filed on May 6, 2022.

(51) Int. Cl. C09D 5/02; C08F 220/18; C08K 5/42; C09D 7/45; C09D 7/63; C09D 133/14

(52) U.S. Cl. CPC C09D 5/022; C08F 220/1804; C09D 5/027; C09D 7/45; C09D 7/63; C09D 133/14; C08K 5/42

(57) ABSTRACT

The present disclosure provides a polymer emulsion which provides a sound damping loss factor of at least 0.1 over a temperature of from (° C.) to 60° C. at 200 Hz.

### FIELD OF THE DISCLOSURE

The present disclosure is generally related to the field of polymers, in particular, liquid applied sound dampening compositions, and to their methods of making and their uses in sound damping applications over a wide temperature range.

### BACKGROUND OF THE DISCLOSURE

To decrease the noise generated by vibrations in vehicles, appliances and machinery, damping materials are applied to the vibrating areas to effectively dissipate the vibrational energy. Applying mastic or asphaltic pads to the vibrating surfaces can dissipate some of the vibrational energy, but this process is labor intensive in the application and expensive as complicated shapes must be produced to cover the critical areas. Vibration damping coatings which are epoxy or PVC based are also used yet these are expensive and contain volatile organic compounds which can create a hazard when applying the coating. Neither of these damping technologies offer a cost effective and low VOC solution for effective damping for vehicles, appliances and machinery.

Formulations containing aqueous emulsions of acrylic polymers are known in the art to be effective in vibration damping. These formulations are water-based and do not contain any hazardous volatile organic chemicals. They are viscous materials which can be applied by various techniques, but are most often robotically sprayed onto the substrate which minimizes the labor of application and allows the material to be applied only in areas which need damping and in customized thicknesses to reach the desired level of vibrational damping.

However, these emulsions often only provide effective damping within a narrow temperature range. There is a need in the industry to improve upon aqueous emulsions for better damping performance and better formulation properties.

### SUMMARY OF THE DISCLOSURE

Disclosed herein are aqueous dispersions of an acrylic polymer comprising particles of the acrylic polymer dispersed in an aqueous medium, wherein aqueous polymer emulsion provides sound damping over a broad temperature range. In another aspect, provided herein are processes for making the aqueous dispersion of acrylic polymers described here. In some embodiments, the aqueous polymer dispersion is prepared using a free radical emulsion polymerization process. In some embodiments, the free radical emulsion polymerization process is performed in a dual feed reactor.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 provides a schematic of the dual feed polymerization reactor used in the syntheses of the acrylic emulsions of the present disclosure.

FIG. 2 provides a computer-generated graph plotting composite loss factor against temperature. The graph demonstrates ideal acoustic performance of an acrylic emulsion across a wide temperature range.

FIG. 3 provides experimental data of the emulsions of the present disclosure on a graph of composite loss factor against temperature.

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

### I. Sound Damping Emulsions

As described above, the present disclosure relates to emulsions for sound damping. More particularly, the present disclosure describes aqueous polymer emulsions in liquid applied sound damping (LASD) formulations to produce highly effective damping materials for use in vehicles, appliances and machinery to mitigate the adverse effects of unwanted vibrations. Also disclosed are a method to produce highly effective aqueous polymer emulsions which can be tuned to provide effective damping over a broad range of temperatures. The emulsions as described herein may also be referred to as “damping formulations” or “damping compositions”.

A typical formulation for a LASD material may comprise one or more of an aqueous polymer emulsion, an inorganic filler, an emulsifying agent and a viscosity modifier. The polymer from the emulsion provides the viscoelastic properties of the final dried product. The proper balance of viscous and elastic properties at the desired temperatures may provide for effective damping properties. The inorganic filler, which may be for example, one or more of calcium carbonate, barium sulfate, mica, may provide mass and stiffness to the dried LASD material. Good interaction between the polymer and the filler may improve the viscoelastic balance and enhance the damping characteristics. The emulsifying agent may be used to help disperse the inorganic fillers in the formulation and allow the highly filled formulation to remain fluid, while thickeners may be added to achieve the correct viscosity profile so the material is fluid enough to be pumped and sprayed yet thick enough so it will not sag and flow when applied. Other ingredients may also be added to harden or soften the product. Colorants may also be added. Defoamers may also be added to help in the elimination of trapped air bubbles and other additives may be included to improve the drying/baking characteristics.

In general, the glass transition temperature (Tg) and molecular weight (Mw) define the sound dampening ability of liquid applied sound dampening coatings. Because the polymer Tg influences the peak sound damping temperature, a widening of the Tg region may contribute to widening the temperature of the sound dampening region. The sound dampening peak may be maximized by adjusting the molecular weight of the polymer. Low Mw polymers are generally favorable for increasing the composite loss factor at a specific temperature. High Mw polymers generally have a higher degree of entanglement meaning that the material can be stretched as far before rupturing. Accordingly, balancing of the polymer's Mn, Mw, Mz and polydispersity index may widen the sound dampening temperature range and also maximize the composite loss factor peak.

The emulsions may be formed through an emulsion polymerization, which relies on the use of small molecule surfactants containing a polar/hydrophilic group and a nonpolar/hydrophobic group. The amphiphilic nature of these materials allows them to effectively stabilize heterogeneous solutions (i.e. polymer particles in water).

The present emulsions may utilize a resin support.

The emulsions may comprise one or more polymers. For example, an emulsion of the present disclosure may comprise two, three, four, or any suitable number of polymers. In embodiments where multiple polymers are used, each polymer may have different properties, such as glass transition temperatures (Tg). Multiple polymers with different Tg values may be combined to form a damping emulsion that provides a broad damping profile over a range of temperatures.

In embodiments where multiple polymers are used, the polymers may be present in any suitable ratio. For example, a damping formulation may comprise four polymers in a weight ratio of W:X:Y:Z. W, X, Y, and Z may each independently be 0.5, 0.6. 0.7, 0.75, 0.8, 0.9, 1, 1.1, 1.2, 1.25, 1.3, 1.4, 1.5, 1.6, 1.7, 1.75, 1.8, 1.9, 2, or any range including any of these values as endpoints. For example, W, X, Y, and Z may each independently be from 0.5 to 2, from 0.5 to 1.5, from 0.75 to 1.5, from 0.75 to 1.25, from 0.75 to 1.2, from 0.9 to 1.1, or any subrange within these ranges. The weight ratios of the polymers may be altered to tune the damping profile of the damping formulation.

The emulsions may comprise a low molecular weight copolymer. For example, the polymers within the emulsion may have a number average molecular weight (Mn) from about 1,000 g/mol to about 75,000 g/mol. This may include a number average molecular weight from about 1,000 g/mol to about 65,000 g/mol or from about 1,000 g/mol to about 50,000 g/mol or from about 1,000 g/mol to about 30,000 g/mol or from about 1,000 g/mol to about 20,000 g/mol, or from about 1,000 g/mol to about 15,000 g/mol, or from about 1,000 g/mol to about 10,000 g/mol. In some embodiments, the low molecular weight copolymer may have a weight average molecular weight from about 1,500 g/mol to about 35,000 g/mol. This includes a weight average molecular weight from about 8,000 g/mol to about 12,000 g/mol.

The polymers of the present formulations may have a molecular weight (Mw) of from 50,000 to 220,000. This may include a molecular weight of from 60,000 to 210,000, from 70,000 to 200,000, from 80,000 to 190,000, from 90,000 to 180,000, from 100,000 to 170,000, from 110,000 to 160,000, from 120,000 to 150,000, from 130,000 to 140,000, or any subrange within any of these ranges.

The polymers of the present formulations may have a Z-average molecular weight (Mz) of from 275,000 to 700,000. This may include a Z-average molecular weight of from 275,000 to 600,000, from 275,000 to 500,000, from 275,000 to 400,000, from 275,000 to 300,000, or any subrange within any of these ranges

The polymers of the present formulations may have a low polydispersity index. This includes a polydispersity index of 10 or lower, 8 or lower, 6 or lower, 4 or lower or 2 or lower.

In some embodiments, the low molecular weight copolymer may be a copolymer of acrylic acid and styrene.

Suitable monomers employed in the preparation of the emulsion include, but are not limited to, acrylic acid, methacrylic acid, styrene, alpha-methylstyrene, hydroxyethylmethacrylate and esters of acrylic acid and methacrylic acid.

In some embodiments, the low molecular weight copolymer may be a carboxylic acid-functional resin. In some embodiments, the carboxylic acid-functional resin may be an alkali soluble resin. In other words, the carboxylic acid-functional resin may react with alkali materials to form ion salts at the carboxylate groups of the polymer, thereby enhancing the water solubility characteristics of the resin. Suitable monomers for preparation of the carboxylic acid-functional resin and the low molecular weight copolymer include monomers such as acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, styrene, methyl styrene, alpha-methyl styrene, ethyl styrene, isopropyl styrene, tertiary-butyl styrene, ethyl methacrylate, methyl methacrylate, butyl acrylate, butyl methacrylate, 2-ethylhexyl acrylate, ethyl acrylate, vinyl acetate, methyl acrylate, open-chain conjugated dienes, 2-hydroxyethyl methacrylate, 2-hydroxyethyl acrylate, methylol acrylamide, glycidyl acrylate, glycidyl methacrylate, vinyl esters, vinyl chloride, or mixtures of any two or more such monomers. In some embodiments, the carboxylic acid-functional support resin includes polymerized monomers of one or more of ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, glycidyl acrylate, glycidyl methacrylate, or mixtures of any two or more such monomers. In one embodiment, the carboxylic acid-functional resin includes polymerized monomers of one or more acrylic acid, ethyl methacrylate, methyl methacrylate, butyl acrylate, butyl methacrylate, 2-ethylhexyl acry late, ethyl acrylate, vinyl acetate, methyl acrylate, 2-hydroxyethyl methacrylate, 2-hydroxyethyl acrylate, glycidyl acrylate, glycidyl methacrylate, styrene, methyl styrene, alpha-methyl styrene, diacetone acrylamide, ureido methacrylate, or a mixture of any two or more such monomers. In some embodiments, the carboxylic acid-functional resin may include a co-polymer including two or more of styrene, methyl methacrylate, and acrylic acid. In some embodiments, the carboxylic acid-functional support resin may include a copolymer of acrylic acid and styrene.

The polymer or polymers used within the emulsions may have a glass transition temperature (Tg) for the individual polymer from −60° C. to 130° C. or any subrange or value within this range. For example, any given polymer within an emulsion may have a Tg from −60° C. to 100° C., from −60° C. to 75° C., from −60° C. to 50° C., from −15° C. to 50° C., from −15° C. to 45° C., from −15° C. to 40° C., from −15° C. to 35° C., from −15° C. to 30° C., from −15° C. to 25° C., from −15° C. to 20° C., from −15° C. to 15° C., from −15° C. to 10° C., from −15° C. to 5° C., from −15° C. to 0° C., from 0° C. to 50° C., from 0° C. to 45° C., from 0° C. to 40° C., from 0° C. to 35° C., from 0° C. to 30° C., from 0° C. to 20° C., from 0° C. to 15° C., from 0° C. to 10° C., from 10° C. to 50° C., from 10° C. to 45° C., from 10° C. to 40° C., from 10° C. to 35° C., from 10° C. to 30° C., from 10° C. to 25° C., from 10° C. to 20° C., or any range including any two of these values as endpoints.

The emulsion or combination of polymers may have a glass transition temperature (Tg) for the individual polymer from −60° C. to 130° C. or any subrange or value within this range. For example, any given polymer within an emulsion may have a Tg from −60° C. to 100° C., from −60° C. to 75° C., from −60° C. to 50° C., from −15° C. to 50° C., from −15° C. to 45° C., from −15° C. to 40° C., from −15° C. to 35° C., from −15° C. to 30° C., from −15° C. to 25° C., from −15° C. to 20° C., from −15° C. to 15° C., from −15° C. to 10° C., from −15° C. to 5° C., from −15° C. to 0° C., from 0° C. to 50° C., from 0° C. to 45° C., from 0° C. to 40° C., from 0° C. to 35° C., from 0° C. to 30° C., from 0° C. to 20° C., from 0° C. to 15° C., from 0° C. to 10° C., from 10° C. to 50° C., from 10° C. to 45° C., from 10° C. to 40° C., from 10° C. to 35° C., from 10° C. to 30° C., from 10° C. to 25° C., from 10° C. to 20° C., or any range including any two of these values as endpoints.

The polymers may be formed from emulsion-polymerizable monomers. Emulsion-polymerizable monomers are known in the art, see e.g. U.S. Pat. Nos. 4,820,762; 7,253,218; 7,893,149; and U.S. Patent Publication No. 2015/0166803. The emulsion polymerizable monomer may include an ethylenically unsaturated monomer. In some embodiments, emulsion polymerizable monomer may include at least one ethylenically unsaturated nonionic monomer. By “nonionic monomer” herein is meant that the copolymerized monomer residue does not bear an ionic charge between pH 1 and 14. Suitable ethylenically unsaturated nonionic monomers include, but are not limited to, (meth)acrylic ester monomers including methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate; (meth)acrylonitrile; (meth)acrylamide: ureido-functional monomers; monomers bearing acetoacetate-functional groups; styrene and substituted styrenes; butadiene; ethylene, propylene, .alpha.-olefins such as 1-decene; vinyl acetate, vinyl butyrate and other vinyl esters; and vinyl monomers such as vinyl chloride, vinylidene chloride.

The emulsion-polymerizable monomer may include acrylate monomers, methacrylate monomers, styrene monomers, or a mixture of any two or more thereof. In some embodiments, the emulsion polymerizable monomer does not include styrene monomers.

In some embodiments, the at least one emulsion polymerizable monomer may be a C₁-C₄ acrylate, a C₁-C₄ (meth)acrylate, or a mixture of any two or more thereof. In some embodiments, the emulsion-polymerizable monomer may be n-butyl acrylate, 2-ethylhexyl acrylate, methyl acrylate, methyl methacrylate, styrene, ethyl acrylate, or a mixture of any two or more thereof.

In some embodiments, the emulsion polymerizable polymer may include one or more keto-functional monomers. Examples of keto-functional monomers include diacetone acrylamide, diacetone methacrylamide, diacetone acrylate, diacetone methacrylate, acetoacetoxy methyl (meth)acry late, 2-(acetoacetoxy)ethyl (meth)acrylate, 2-acetoacetoxypropyl(meth)acrylate, butanediol-1,4-acrylate-acetylacetate, vinyl methyl ketone, vinyl ethyl ketone, and vinyl isobutyl ketone, allyl acetoacetate, vinyl acetoacetate, or vinyl acetoacetamide. In one embodiment, the emulsion polymerizable polymer includes a repeat unit derived from diacetone acrylamide.

The emulsions may be formed thorough an emulsion polymerization reaction, which may involve at least one emulsion polymerizable monomer, a low molecular weight copolymer, and other ingredients and/or reagents, such as an initiator. In some embodiments, the emulsion polymerization occurs in a dual-feed reactor.

The initiator may be a water-soluble compound for ready mixing and blending with the emulsions. Non-limiting examples of water-soluble initiators for the emulsion polymerization include ammonium salts and alkali metal salts of peroxy disulfuric acid, e.g., sodium peroxodisulfate, hydrogen peroxide or organic peroxides, e.g., tert-butyl hydroperoxide. The initiator may be a thermal initiator. Suitable initiators include, but are not limited to 2,2′-azobis(2-methylpropionamidine) dihydrochloride, ammonium persulfate, sodium persulfate, and potassium persulfate. Also suitable are reduction-oxidation (redox) initiator systems. The redox initiator systems consist of at least one, usually inorganic, reducing agent and an organic or inorganic oxidizing agent. The oxidizing component comprises, for example, the emulsion polymerization initiators already identified above. The reducing components comprise, for example, alkali metal salts of sulfurous acid, such as, for example sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems can be used along with soluble metal compounds whose metallic component is able to exist in a plurality of valence states. Typical redox initiator systems are, for example, ascorbic acid/iron (II) sulfate/sodium peroxydisulfate, tert-butyl hydroperoxide/sodium disulfite, tert-butyl hydroperoxide/Na hydroxymethanesulfinic acid. The individual components, the reducing component for example, may also be mixtures, an example being a mixture of the sodium salt of hydroxymethanesulfinic acid and sodium disulfite. The stated compounds are used usually in the form of aqueous solutions, with the lower concentration being determined by the amount of water that is acceptable in the dispersion, and the upper concentration by the solubility of the respective compound in water. Generally speaking, the concentration is 0.1% to 30% by weight, preferably 0.5% to 20% by weight, more preferably 1.0% to 10% by weight, based on the solution. The amount of the initiators is generally 0.1% to 10% by weight, preferably 0.5% to 5% by weight, based on the monomers to be polymerized. It is also possible for two or more different initiators to be used in the emulsion polymerization.

In some embodiments, an initiator may be ammonium persulfate and an oxidizer may be t-butyl hydroperoxide. In such case, a weight ratio between ammonium persulfate and t-butyl hydroperoxide may range from 40:1 to 2:1 or from 30:1 to 4:1 or any subrange or value within these ranges.

In some embodiments, the emulsion includes one or more chain transfer agents to control molecular weight, branching and/or gel formation. Exemplary chain transfer agents include, but are not limited to, isooctyl mercaptopropionate (IOMPA), butylmercaptopropionate, 2-ethyl hexylmercaptopropionate, tertiary dodecylmercaptan, and thioglycerol.

In general, the amounts of the chain transfer agents employed can be varied from 0.05% to 1% by weight, based on the total amount of the monomers to be polymerized.

The polymer emulsions described herein may also contain a surfactant. In some embodiments, the surfactant is anionic or non-ionic. In some embodiments, the surfactant contains one or more fatty alcohol alkoxylates. In further embodiments, the one or more fatty alcohol alkoxylates are fatty alcohol ethoxylates, fatty alcohol propoxylates, or any combination thereof. In some embodiments, the surfactant contains one or more ethylene oxide/propylene oxide block copolymers. In some embodiments, the surfactant contains one or more fatty alcohol ethoxylates. In some embodiments, the surfactant contains one or more alkylsulfosuccinate ethoxylates. In some embodiments, the surfactant contains one or more fatty alcohols having an alkyl chain length of about 12 to about 18 carbons; and a degree of ethoxylation of about 10 to about 80 molar ethylene oxide units. In some embodiments, the surfactant includes non-ionic surfactants. In some embodiments, the surfactant includes anionic surfactants. In some embodiments, the anionic surfactant includes one or more alkyl sulfonates, alkyl benzene sulfonates, alkyl sulfates, alkyl benzene sulfates, phosphates, phosphinates, fatty carboxylates, or any combination of two or more thereof.

In general, the amounts of the surfactants employed can be varied from 0.1% to 1% by weight, based on the total amount of the monomers to be polymerized.

In some embodiments, the damping formulation may include at least one of a filler, a defoaming agent, a rheological modifier, an emulsifying agent (i.e. “dispersing agent” or “dispersant”), a coalescent agent, a pigment, or a biocide.

In some embodiments, the damping formulation may include one or more filler, which may constitute from about 40 wt. % to about 90 wt. % or from 45 wt. % to 85 wt. % or from 50 wt. % to 80 wt. % or any value or subrange within these ranges of the formulations. Examples of fillers may include, but are not limited to, calcium carbonate, barium sulfate, glass filler, magnesium carbonate, plastic microsphere, mica, powdered slate, montmorillonite flakes, glass flakes, metal flakes, graphite, graphene, talc, iron oxide, clay minerals, cellulose fibers, mineral fibers, carbon fibers, glass or polymeric fibers or beads, ferrite, calcium carbonate, calcium magnesium carbonate, calcium silicate, barytes, ground natural or synthetic rubber, silica, aluminum hydroxide, alumina and mixtures thereof. In some embodiments, the damping formulation may include a mixture of any two or more such fillers.

In some embodiments, the damping formulation may include a defoaming agent (a defoamer). Examples of defoaming agents include Foamaster® S (produced by BASF), Rhodoline® DF 540 (produced by Rhodia)® 635 (produced by Solvay), Foamaster® MO 2170 (produced by BASF), or Foamaster® MO 2190 (produced by BASF). The damping formulation may include as much of a defoaming agent as needed to provide the desired foaming characteristics. In some embodiments, the defoaming agent may constitute less than 1 wt. % of the damping formulation. In some embodiments, the damping formulation more than 0) wt. % up to about 1 wt. % of the defoaming agent.

In some embodiments, the damping formulation may include a thickener or a rheological modifier. Examples of rheological modifiers include Rheovis® HS 1152; Rheovis® HD 1152 (produced by BASF) or Rheovis® AS 1130 (produced by BASF). The damping formulation may include as much of a rheological modifier as needed to provide the desired solution characteristics. In some embodiments, the formulation may include less than 1 wt. % of the rheological modifier. In other embodiments, the formulation may include more than 0 wt. % up to about 1 wt. % of the rheological modifier.

In some embodiments, the damping formulation includes a dispersant. One non-limiting example of a dispersant is Dispex® CX 4320 (produced by BASF). The damping formulation may include as much dispersant as need to provide the desired characteristics for the formulation. In some embodiments, the formulation may include from 0.1 to 2.0 wt. % or from 0.25 to 1.5 wt. % or from 0.5 to 1.0 wt. % or any value or subrange within these ranges.

In some embodiments, the damping formulation may include a biocide. Suitable non-limiting examples of a biocide include Acticide® MBS (a mixture of 1,2-benzisothiazolin-3-one (2.5%) and 2-methyl-4-isothiazolin-3-one (2.5%)), Acticide® MV-14 (a mixture of 5-chloro-2-methyl-2H-isothiazol-3-one and 2-methyl-2H-isothiazol-3-one in a ratio of 3:1 respectively), and Acticide® CEM 2 (a mixture of 1,2-benzisothiazol-3 (2H)-one (9.3-10.7%), 2-methylisothiazol-3 (2H)-one (4.7-5.2%), and 5-chloro-2-methyl-2H-isothiazol-3-one (0.9-1.1%).

### II. Methods of Making and Applying Emulsions

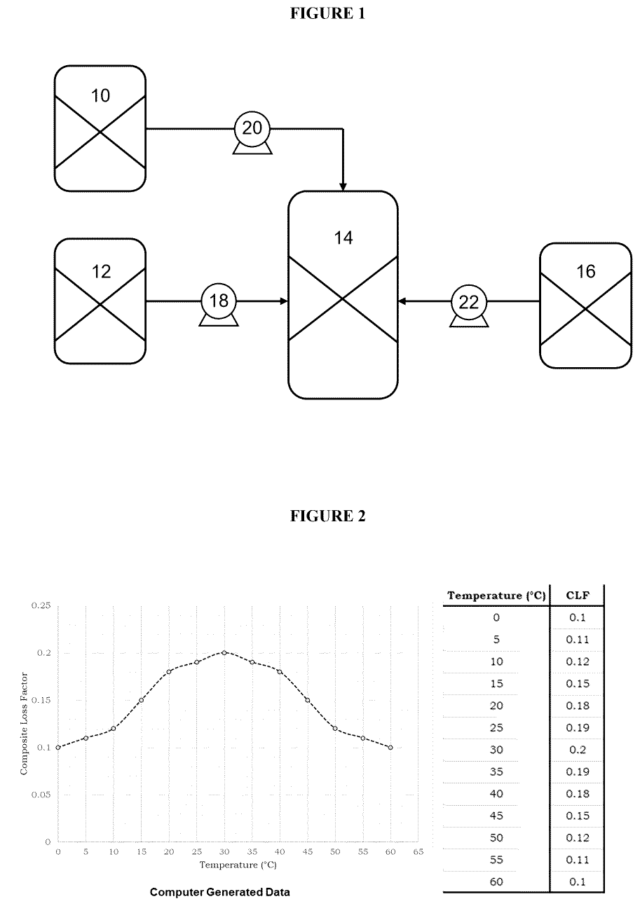

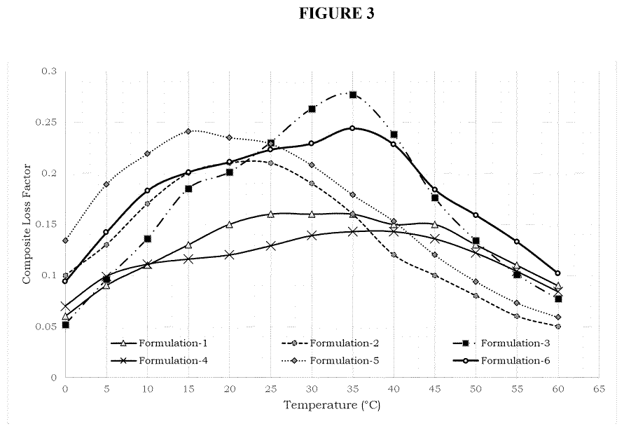

The emulsion polymerization reactions of the present disclosure may be performed in a dual feed reactor such as the one depicted in FIG. 1. The reactor may be equipped with a water bath, mechanical stirrer, temperature control probes, feeding tubes for monomer addition, feeding tubes for initiator addition, and reflux condensers. In general, each tank is charged with the contents listed below in Table 1.

TABLE 1
Charges for different vessels in dual
feed reactor depicted in FIG. 1.

| Vessel | Charge |
|---|---|
| Tank 12 | Pre emulsion (DI-Water + Surfactant + |
| | Monomer A + Optionally Chain Transfer |
| | Agent |
| Tank 16 | Neat monomer (Monomer B) |
| Tank 10 | Initiator (DI-Water + Initiator + Optionally |
| | Buffer) |
| Reactor 14 | Reactor Charge (DI-Water + Surfactant + |
| | Seed + Acid Monomer |

Initially, reactor 14 is charged with DI-water which is then heated to 85° C. Acid monomer at 80° C. is added to reactor 14 at one shot followed by an initial initiator shot from tank 10 which is pumped into reactor 14 via pump 20. Then, the pre-emulsion feed in tank 12 comprising DI-water, surfactant, Monomer A, and optionally a chain transfer reagent is pumped through pump 18 to feed into reactor 14. Simultaneously, the neat monomer feed in tank 16 comprising Monomer A is pumped through pump 22 into reactor 14. After 15 minutes of pre-emulsion, a second charge of initiator feed from tank 10 is pumped into reactor 14. The total feeding time is three hours. At the end of pre-emulsion, the neat monomer and initiator feeds hold the reactor at 85° C. for 30 minutes and then flush water is added to reduce the temperature to 70° C. After completion of the chemical stripping process, reactor 14 is cooled to room temperature before the polymer finished polymer is filtered into a storage container.

The damping formulation may be deposited on a source of mechanical vibrations by a number of ways. For example, in some embodiments, the damping formulation may be sprayed on a source of mechanical vibrations. Yet in some embodiments, the damping formulation may be painted on a source of mechanical vibrations.

A source of mechanical vibration may be a body, which is capable of producing or transmitting vibrations. The LASD formulations disclosed herein can be applied to a variety of bodies capable of producing or transmitting vibrations. Non-limiting examples of such bodies include an auto interior cabin; pickup truck interior cabin and underside of truck bed: interior panels of trucks: walls, ceilings, and floors of rail cars; aerospace vehicles or devices: elevators: washing machines: clothes driers: automatic dishwashers; and the underside of sinks.

The damping formulations provided herein may also be applied to a variety of materials, including, for example, metal, steel, aluminum, plastic, wood, wallboard, or gypsum board.

### III. Properties of Emulsions

When applied to a substrate, the damping formulations may provide sound damping over a broad range of temperatures at any suitable frequency (e.g. 100 Hz, 200 Hz, 300 Hz, 400 Hz, 500 Hz, etc.). The damping formulations may provide a composite loss factor of at least 0.1 at 200 Hz over a temperature range of at least 20° C., at least 25° C., at least 30° C., at least 35° C., at least 40° C., at least 45° C., at least 50° C., at least 55° C., at least 60° C., or any range including any two of these values as endpoints. For example, the formulations may provide a loss factor of at least 0.1 at 200 Hz over a temperature range from 20° C. to 60° C., from 30° C. to 60° C., from 40° C. to 60° C., or any subrange within these ranges.

Stated differently, the formulations herein may provide a composite loss factor of at least 0.1 at 200 Hz at a temperature from 0° C. to 60° C., from 0° C. to 50° C., from 10° C. to 60° C., from 20° C. to 60° C., from 10° C. to 50° C., from 20° C. to 50° C., from 20° C. to 60° C., from 30° C. to 60° C., or any subrange within any of these ranges.

While this invention has been described as having exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The examples below are intended to further illustrate certain aspects of the methods and compositions described herein and are not intended to limit the scope of the claims.

### EXAMPLES

The following examples are put forth so as to provide those of ordinary skill in the art with a complete disclosure and description of how the compositions and/or methods claimed herein are made and evaluated and are intended to be purely exemplary and are not intended to limit the scope of the disclosure. Unless indicated otherwise, parts are parts by weight, temperature is in ° C. or is at ambient temperature, and pressure is at or near atmospheric.

### Example 1: Synthesis of Acrylic Emulsion Formulations

Initially, the polymerization reactor was charged with a required amount of DI-water, about 25% of the total surfactant amount and seed polymer. The reactor was heated to 85° C. and at 80° C. acid monomer was added at one shot. Then at 85° C. an initial initiator shot (about 25% of total initiator solution) was instantly added. After the initiator shot, pre-emulsion neat monomer feeds were started simultaneously. After 15 minutes of pre-emulsion and neat monomer feeds, the second charge of initiator feed was started. The total feeding (Neat Monomer+Pre-emulsion+Initiator) time was 3 hours. At the end of pre-emulsion, the neat monomer and initiator feed held the reactor at 85° C. for 30 minutes and then flush water was added to reduce the reactor temperature to 70° C. At 70° C., delayed oxidizer and reducer feeds were started to reduce the residual monomers. After the completion of chemical strip process, the reaction was cooled to room temperature. Finally post addition solution was added and the reactor mixed the contents for 15 minutes before filtering the polymer in storage container.

TABLE 2
Mass breakdown of formulations 1-6.

| | Total Formulation (grams) | | | | | |
|---|---|---|---|---|---|---|
| Emulsion Number | 1 | 2 | 3 | 4 | 5 | 6 |
| Reactor Charge | | | | | | |
| DI-Water | 230.00 | 227.77 | 379.87 | 380.24 | 379.50 | 354.29 |
| Polystep LAS-40 | 5.05 | 5.00 | 4.60 | 4.60 | 4.59 | 3.47 |
| Seed Polymer | 15.37 | 15.22 | 14.01 | 14.02 | 14.00 | 14.08 |
| Methacrylic Acid | 0.00 | 19.49 | 8.97 | 8.97 | 8.96 | 9.01 |
| Initiator Feed | | | | | | |
| DI-Water | 236.11 | 233.76 | 208.45 | 208.66 | 208.25 | 141.90 |
| Sodium Bicarbonate | 0.59 | 0.58 | 0.27 | 0.27 | 0.27 | 0.27 |
| Sodium Persulfate | 8.85 | 8.77 | 8.07 | 8.08 | 8.06 | 5.41 |
| Pre-Emulsion | | | | | | |
| DI-Water | 150.60 | 146.39 | 164.53 | 164.37 | 164.68 | 166.97 |
| Polystep LAS-40 | 15.14 | 14.99 | 13.79 | 13.81 | 13.78 | 10.40 |
| Butylacrylate | 491.90 | 487.15 | 416.91 | 417.31 | 416.50 | 418.95 |
| 2-Hydroxyethylacrylate | 49.19 | 0.00 | 67 24 | 67.31 | 67.18 | 67.57 |
| Ethyldiglycol Acrylate | 0.00 | 48.71 | 0.00 | 0.00 | 0.00 | 0.00 |
| Methacrylic Acid | 19.68 | 0.00 | 0.00 | 0.00 | 0.00 | 0.00 |
| t-Dodecylmercaptan | 0.00 | 9.74 | 2.69 | 1.79 | 3.58 | 2.70 |
| Neat Momomer | | | | | | |
| Methylmethacrylate | 423.03 | 418.95 | 403.46 | 403.85 | 403.06 | 405.44 |
| Flush Water | | | | | | |
| DI-Water | 102.49 | 111.99 | 46.25 | 45.82 | 46.71 | 138.49 |
| Chase Oxidizer | | | | | | |
| DI-Water | 24.60 | 24.36 | 22.44 | 22.44 | 1.28 | 1.28 |
| t-bhp, trigonox aw-70 | 1.41 | 1.39 | 1.28 | 1.28 | 22.44 | 22.44 |
| Chase Reducer | | | | | | |
| DI-Water | 25.02 | 24.78 | 22.82 | 22.82 | 0.90 | 0.90 |
| Sodium Metabisulfite | 0.98 | 0.97 | 0.90 | 0.90 | 22.82 | 22.91 |
| Post Addition | | | | | | |
| 28% Ammonium | 5.25 | 5.25 | 4.80 | 4.81 | 4.80 | 4.83 |
| Hydroxide | | | | | | |
| DI-Water | 9.46 | 9.46 | 8.65 | 8.65 | 8.64 | 8.69 |
| Total | 1814.72 | 1814.72 | 1800.00 | 1800.00 | 1800.00 | 1800.00 |

TABLE 3
Mw distributions for formulations 1-6.

| Emulsion | Mn | Mw | Mz | Polydispersity |
|---|---|---|---|---|
| 1 | 21802 | 218463 | 767367 | 10.06 |
| 2 | 13779 | 44918 | 119247 | 3.26 |
| 3 | 9143 | 96745 | 315305 | 10.58 |
| 4 | 11029 | 156703 | 639136 | 14.21 |
| 5 | 14948 | 72159 | 199749 | 4.83 |
| 6 | 11549 | 103824 | 362105 | 8.99 |

TABLE 4
Mass balance of a standard LASD coating formulation.

| Raw Materials | Batch Size (g) |
|---|---|
| Acylic Emulsion | 45.0000 |
| DI-Water | 2.0200 |
| Dispex CX 4230 | 0.4896 |
| Foamaster MO 2190 (WBA) | 0.1530 |
| Dipropylene Glycol | 1.0404 |
| Aurasperse W7017 (Black) | 0.2040 |
| Pluronic F87 (30% Solution) | 0.6120 |
| Penford Gum 280 | 2.2847 |
| Dualite U018-130W | 0.7242 |
| Bentone CT | 1.1424 |
| Mica | 13.5453 |
| Calcium Carbonate | 32.2720 |
| Rheovis AS 1130 | 0.5100 |
| Total | 100.00 |

TABLE 5
Acoustic performance of formulations 1-6.
Composite Loss Factor at SAE Bar-B

| Temperature | Formulation | | | | | |
|---|---|---|---|---|---|---|
| (° C.) | 1 | 2 | 3 | 4 | 5 | 6 |
| 0 | 0.06 | 0.10 | 0.05 | 0.07 | 0.13 | 0.10 |
| 5 | 0.09 | 0.13 | 0.10 | 0.10 | 0.19 | 0.14 |
| 10 | 0.11 | 0.17 | 0.14 | 0.11 | 0.22 | 0.18 |
| 15 | 0.13 | 0.20 | 0.19 | 0.12 | 0.24 | 0.20 |
| 20 | 0.15 | 0.21 | 0.20 | 0.12 | 0.24 | 0.21 |
| 25 | 0.16 | 0.21 | 0.23 | 0.13 | 0.23 | 0.22 |
| 30 | 0.16 | 0.19 | 0.26 | 0.14 | 0.21 | 0.23 |
| 35 | 0.16 | 0.16 | 0.28 | 0.14 | 0.18 | 0.24 |
| 40 | 0.15 | 0.12 | 0.24 | 0.14 | 0.15 | 0.23 |
| 45 | 0.15 | 0.10 | 0.18 | 0.14 | 0.12 | 0.18 |
| 50 | 0.13 | 0.08 | 0.13 | 0.12 | 0.09 | 0.16 |
| 55 | 0.11 | 0.06 | 0.10 | 0.10 | 0.07 | 0.13 |
| 60 | 0.09 | 0.05 | 0.08 | 0.08 | 0.06 | 0.10 |

The invention claimed is:

1.-20. (canceled)

21. A polymer emulsion composition comprising:
at least one block copolymer;
at least one chain transfer agent
at least one surfactant
wherein the composition provides a composite loss factor of at least 0.1 at 200 Hz at a temperature from 0° C. to 60° C.

22. The polymer emulsion of claim 21, wherein the emulsion composition has a glass transition temperature from −60° C. to 130° C.

23. The polymer emulsion composition of claim 21, wherein the Mn is 8000 to 12,000.

24. The polymer emulsion composition of claim 21, wherein the Mw is 50,000 to 220,000.

25. The polymer emulsion composition of claim 21, wherein the Mz is 275,00 to 700,000.

26. The polymer emulsion composition of claim 21, wherein the PDI is less than 10.

27. The polymer emulsion of claim 21, wherein the copolymer is an acrylic or styrene-acrylic copolymer.

28. The polymer emulsion composition of claim 21 wherein the polymer comprises the functional monomers acrylic acid, methacrylic acid, styrene, alpha-methylstyrene, hydroxyethylmethacrylate, esters of acrylic acid, or methacrylic acid.

29. The polymer emulsion of claim 21, wherein the chain transfer agent is present in an amount of from 0.01 wt. % to 1 wt. % based on the total weight of the composition.

30. The polymer emulsion of claim 21, wherein the chain transfer agent is selected from the group consisting of isooctyl mercaptopropionate (IOMPA), butylmercaptopropionate, 2-ethyl hexylmercaptopropionate, tertiary dodecylmercaptan, and thioglycerol.

31. The polymer emulsion of claim 21, wherein the surfactant is present in an amount of from 0.3 wt. % to 1 wt. % based on the total weight of the composition.

32. The polymer emulsion of claim 21, wherein the surfactant is selected from the group consisting of fatty alcohol alkoxylates, fatty alcohol ethoxylates, ethylene oxide block copolymers, propylene oxide block copolymers, alkyl sulfonates, alkyl benzene sulfonates, alkyl sulfates, alkyl benzene sulfates, phosphates, phosphinates, or fatty carboxylates.

33. The polymer emulsion of claim 21, wherein the emulsion further comprises an aqueous resin solution, rheology modifier, wetting agent, defoamer, thickener, stabilizer, buffering agent, salt, preservative, fire retardant, biocide, corrosion inhibitor, cross-linker, lubricant, colorant, dye, wax, perfume, or filler.

34. A method for producing the polymer emulsion of claim 21 in dual feed reactor comprising
(i) charging a polymerization reactor with DI-water, surfactant, and seed polymer;
(ii) adding an initiator to the reactor;
(iii) feeding monomers into the reactor from two separate tanks to form a polymer composition;
(iv) adding flush water to the reactor;
(v) chemically stripping the polymer composition; and
(vi) filtering the polymer composition into a storage container.

35. The method of claim 34, wherein the monomer feeding is ramped-up and ramped-down gradually.

36. The method of claim 34, wherein the dual power feed synthesis process produces gradient molecular weight polymeric chains.

37. The method of claim 34, wherein the dual power feed synthesis process produces a wide Tg of the resulting polymer dispersion.

38. The method of claim 34, wherein the dual power feed synthesis process produces a gradient Tg.

39. A substrate coated with the composition of claim 21.

40. The coated substrate of claim 39, wherein the substrate is steel, aluminum, plastic, wood, wallboard, or gypsum board.
